(19) United States
(12) Patent Application Publication
(10) Pub. No.: US 2002/0020788 A1
(43) Pub. Date: Feb. 21, 2002

(54) Folding stand

(76) Inventor: Juergen Pensel, Altstatten (CH)

Correspondence Address: Simpson, Simpson & Snyder, PLLC, 5555 Main Street, Williamsville, NY, 14221, US

(21) Appl. No.: 09/927,755

(22) Filed: Aug. 10, 2001

(30) Foreign Application Priority Data
Aug. 16, 2000 (DE) 200 14 108.2

(51) Int. Cl. F16L 3/00

(52) U.S. Cl. 248/121; 248/166

(57) ABSTRACT

A stand for a surgical microscope or other optical instrument is improved by providing separation units for dividing support members of the stand into separable portions for compacting the stand into a storage state characterized by a lower center of gravity and a smaller storage volume. In one embodiment, the stand comprises a column and an extension arm supported by the column. A first separation unit divides the column into upper and lower portions, while a pair of second separation units divides the extension arm into a middle portion and two opposite end portions. Each separation unit preferably includes a vibration-damping element.

### CROSS REFERENCE TO RELATED APPLICATIONS

This invention claims priority of the German Utility Model application 200 14 108.2 filed Aug. 16, 2000 which is incorporated by reference herein.

### FIELD OF THE INVENTION

The invention concerns a stand for an optical viewing device, in particular for a surgical stereomicroscope.

### BACKGROUND OF THE INVENTION

Stands are used for many optical viewing devices (microscopes, telescopes, binoculars, video, theodolites, photography, etc.). A stand eliminates the need to hold the viewing device manually, and a jitter-free and stable image is created for the viewer.

The viewer nevertheless needs to have the capability to pivot and orient the viewing device in any desired direction so as always to have the most optimum possible view of the desired image field.

Stands should ideally possess the following properties, among others:

Stability;

Tipover resistance;

Flexibility; and

Pivotability.

In presently known stands, the properties required above are achieved by suitable selection of materials, e.g. by the use of composite materials, and by way of design features. These design-related measures are directed principally toward the stationary state of the stand. Transport of the stand, with or without a viewing unit, is not taken into consideration in this context.

In clinical applications, the following additional requirements result from the fact that the viewing units must be displaced and in some cases stored:

Tipover resistance during transport;

Small volume for transport and storage; and

Protection of the viewing unit during transport.

The existing systems, in particular stands in the field of surgical microscopes, are afflicted with disadvantages in terms of the following:

Center of gravity is much too high, resulting in little tipover resistance when transported;

The stand, or the stand including the viewing unit, is too bulky when packed;

Too little damage protection for the viewing unit;

Storage footprint too large; and

Transport volume too large.

### SUMMARY OF THE INVENTION

It is thus the object of the invention to find an improvement which eliminates the disadvantages indicated above and meets both the requirements of a standard stand and the special requirements of a stand for surgical microscopy, in particular as regards storage and transport.

This object is achieved by the use of a foldable stand which, by way of assembly separation units, either divides the various stand supports into shorter elements and/or makes the individual supports easily removable.

Bendable, foldable, or telescopable reduction units are used, for example, for the assembly separation units.

It is thereby possible, without impairing the stationary properties of the stand, to achieve for transport and storage, both with and without a viewing unit, the improvements listed below:

a) Lowering of the center of gravity during transport;

b) Reducing the transport volume;

c) Protecting the viewing unit, if the separation units are arranged and configured; and

d) Reducing the storage footprint.

A particular development of the invention consists in

a) combining said units with the conventionally known materials for vibration damping, or configuring the separation units themselves as vibration-damping elements; and

b) integrating into the separation units the necessary electrical and electro-optical (e.g. light-guiding) connections inside the stand.

### BRIEF DESCRIPTION OF THE DRAWINGS

The invention will be described below, in exemplary embodiments, with reference to the schematic drawings, in which:

FIG. 1 shows a symbolic configuration of the stand in the ready-to-use state;

FIG. 2 shows the stand of FIG. 2 in the folded state; and

FIGS. 3 a-d show further embodiments of the solution according to the present invention.

### DETAILED DESCRIPTION OF THE INVENTION

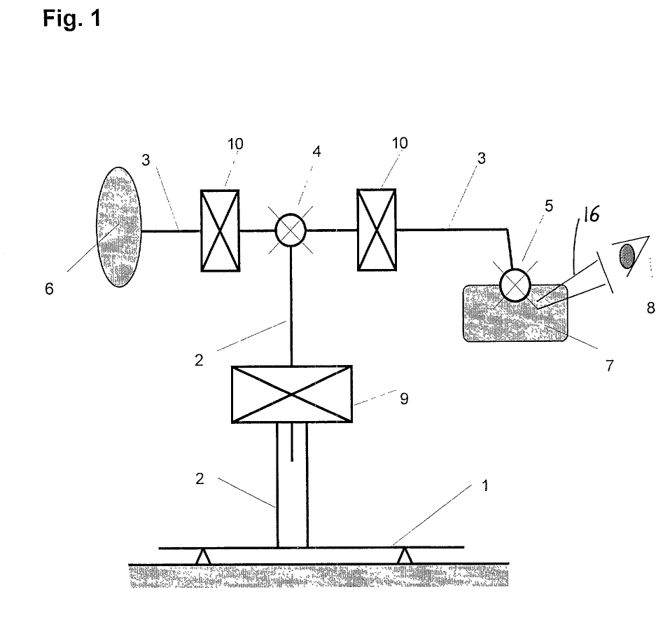

In the symbolic configuration of a stand 15 shown in FIG. 1, stand column 2 is mounted in fixed or removable fashion on a stand foot 1. Stand column 2 is divided into two parts by a first separation unit 9. Located on the upper part of stand column 2 is a rotatable and pivotable joint 4 which connects stand column 2 to an extension arm 3 which serves as support for a viewing unit 7 and counterweight 6. Extension arm 3 is in turn divided into portions by two or more second separation units 10. A removable joint 5 rotatably and pivotably connects a viewing unit 7 to extension arm 3. Also schematically indicated, in addition to viewing unit 7, is an eyepiece 16 for the eye of a viewer 8.

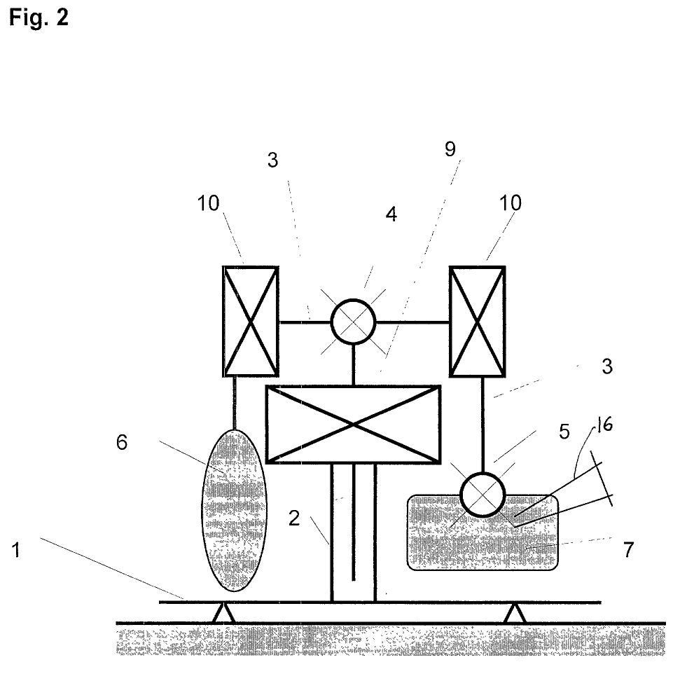

FIG. 2 symbolically shows stand 15 in the folded state, which constitutes the transport and storage state. Stand 15 symbolically depicted in FIG. 1 is folded and/or collapsed in telescoping fashion at separation units 9, 10. As a result, the overall center of gravity of stand 15 is displaced downward, viewing unit 7 is protected, and transport and storage volume is reduced.

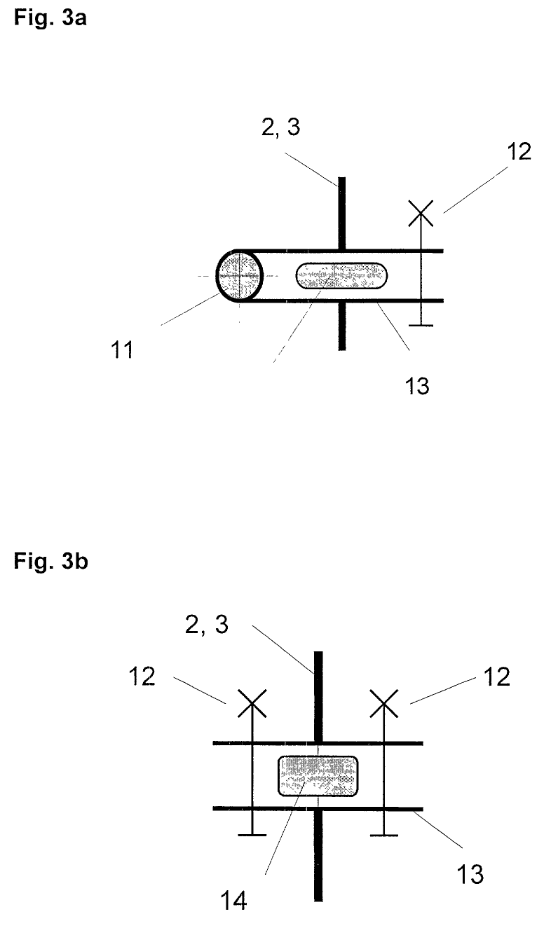

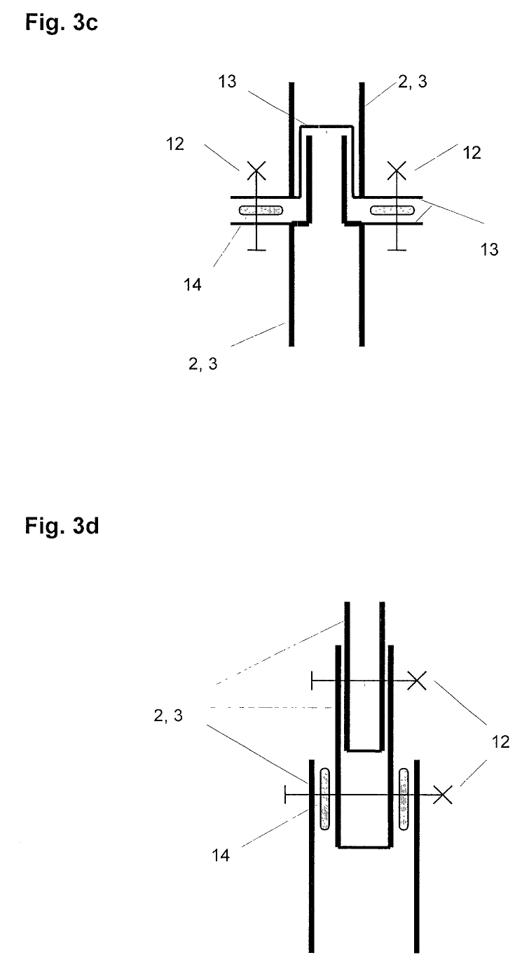

FIGS. 3a through 3d schematically show various exemplary embodiments of possible assembly separation units by folding at a joint 11 (FIG. 3a), by way of a mounting plate (FIG. 3b), by insertion (FIG. 3c), or by way of a telescoping connection (FIG. 3d); stand support 2 and extension arm 3, joint plates 13, fastening units 12, and examples of possible damping elements 14 are indicated.

Foldable stand 15 is a stand which in the stationary state corresponds to a normal stand, for example a stand for a surgical microscope. In order to make said stand 15 as shown in FIG. 1, including viewing unit 7, better able to be transported and stored, it is configured in foldable fashion.

In this context, stand column 2, which is mounted in preferably removable but rigid fashion on stand foot 1, is divided by a separation unit 9 into two or more parts. Extension arm 3, which supports viewing unit 7 and counterweight 6, is connected to stand column 2 by means of a rotatable and pivotable joint 4, and is divided by separation units 10 into several parts. Viewing unit 7 is connected to extension arm 3 in standard fashion via a removable, rotatable, and pivotable joint 5.

For transport and storage, as shown in FIG. 2, stand support 2 and extension arm 3 can be folded together and/or collapsed in telescoping fashion at separation units 9, 10.

According to the present invention, therefore,

a) the center of gravity of stand 15, including viewing unit 7, is greatly lowered;

b) transport and storage volume are decreased; and

c) as a result of a protected arrangement, the risk of damage to the viewing unit is reduced.

As shown in FIGS. 3a through 3d, separation units 9, 10 can be configured in various forms, for example by folding, by way of a mounting plate, by insertion, or by way of a telescoping connection. In order additionally to improve the existing properties of stand 15 in terms of freedom from vibration, the separation units can additionally be configured, by way of design features or the use of suitable materials, in vibration-damping fashion. As a result, the standard properties of a stand 15 not only are entirely retained, but are even further improved.

The invention is of course not limited to a stand for a surgical microscope, but can advantageously be applied wherever optical devices, such as telescopes, binoculars, video cameras, theodolites, photographic cameras, etc. are mounted on stands.

PARTS LIST

1 Stand foot

2 Stand column

3 Extension arm (stand support for viewing unit and counterweight)

4 Joint between stand column and extension arm: removable, rotatable, and pivotable

5 Joint between extension arm and viewing unit: removable, rotatable, and pivotable

6 Counterweight

7 Viewing unit

8 Viewer

9 Stand column separation unit

10 Extension arm separation unit

11 Pivotable joint, possibly of vibration-damping configuration

12 Fastening unit, e.g. bolt or . . .

13 Joint plate, possibly of vibration-damping and stabilizing configuration

14 Damping element

15 Stand

16 Eyepiece

What is claimed is:

1. In a stand for holding an optical instrument, said stand having an elongated support member, the improvement comprising:
a separation unit for dividing said support member into adjacent portions, said separation unit enabling said portions of said support member to be positioned to define a storage state for said stand that more compact than a normal usage state of said stand.

2. The improvement as defined in claim 1, wherein said stand has a lower center of gravity in said storage state than in said normal usage state.

3. The improvement as defined in claim 1, wherein said stand has a smaller storage volume in said storage state than in said normal usage state.

4. The improvement as defined in claim 1, wherein said stand has as support members a column and an extension arm connected to said column, and said stand comprises a first separation unit dividing said column into upper and lower portions, and a pair of second separation units dividing said extension arm into a pair of end portions and a middle portion.

5. The improvement as defined in claim 4, wherein said stand supports a surgical microscope mounted on one of said end portions of said extension arm and said surgical microscope is arranged in protected fashion when said stand is in said storage state.

6. The improvement as defined in claim 1, wherein said separation unit provides a folding connection between said adjacent portions of said support member.

7. The improvement as defined in claim 4, wherein said first separation unit provides a folding connection between said upper and lower portions of said column.

8. The improvement as defined in claim 4, wherein said pair of second separation units provides respective folding connections between each of said pair of end portions and said middle portion of said extension arm.

9. The improvement as defined in claim 1, wherein said separation unit comprises opposed mounting plates associated one with each of said adjacent portions of said support member.

10. The improvement as defined in claim 4, wherein said first separation unit comprises opposed mounting plates associated one with said upper portion of said column and another with said lower portion of said column.

11. The improvement as defined in claim 4, wherein each of said pair of second separation units comprises opposed mounting plates associated one with said middle portion of said extension arm and another with a respective one of said pair of end portions of said extension arm.

12. The improvement as defined in claim 1, wherein said separation unit provides an insertable plug connection between said adjacent portions of said support member.

13. The improvement as defined in claim 4, wherein said first separation unit provides an insertable plug connection between said upper and lower portions of said column.

14. The improvement as defined in claim 4, wherein said pair of second separation units provides respective insertable plug connections between each of said pair of end portions and said middle portion of said extension arm.

15. The improvement as defined in claim 1, wherein said separation unit provides a telescoping connection between said adjacent portions of said support member.

16. The improvement as defined in claim 4, wherein said first separation unit provides a telescoping connection between said upper and lower portions of said column.

17. The improvement as defined in claim 4, wherein said pair of second separation units provides respective telescoping connections between each of said pair of end portions and said middle portion of said extension arm.

18. The improvement as defined in claim 2, wherein said separation unit comprises a vibration-damping element.

19. The improvement as defined in claim 4, wherein said first separation unit and each of said pair of second separation units comprises a vibration-damping element.

20. The improvement as defined in claim 2, wherein an electrical connection is integrated into said separation unit.

21. The improvement as defined in claim 2, wherein an electro-optical connection is integrated into said separation unit.

22. The improvement as defined in claim 2, wherein a light-guiding connection is integrated into said separation unit.
